(19) United States
(12) Patent Application Publication
(10) Pub. No.: US 2012/0314214 A1
(43) Pub. Date: Dec. 13, 2012

(54) Laser Induced Breakdown Spectroscopy Having Enhanced Signal-to-Noise Ratio

(76) Inventors: DENNIS R. ALEXANDER, Lincoln, NE (US); TROY ANDERSON, Omaha, NE (US); JOHN C. BRUCE, III, Lincoln, NE (US)

(21) Appl. No.: 13/490,808

(22) Filed: Jun. 7, 2012

Related U.S. Application Data
(60) Provisional application No. 61/494,221, filed on Jun. 7, 2011.

(51) Int. Cl. G01J 3/30

(52) U.S. Cl. 356/318

(57) ABSTRACT

A material can be analyzed using short pulses by applying a first pulse and a second pulse to the material in which the second pulse is delayed relative to the first pulse. The first and second pulses are directed toward a material along collinear paths, and the material is ablated using the first pulse to cause particles to be emitted from the surface of the material. The emitted particles are atomized and/or ionized using the second pulse, and the radiation from the atomized and/or ionized particles is analyzed.

### CROSS-REFERENCE TO RELATED APPLICATION

Pursuant to 35 USC §119(e), this application claims the benefit of U.S. provisional application 61/494,221, filed on Jun. 7, 2011, the content of which is incorporated by reference.

### FEDERALLY SPONSORED RESEARCH

This invention was made with government support under Army Research Office MURI: W911NF-06-1-0446. The government has certain rights in the invention.

### BACKGROUND

Laser induced breakdown spectroscopy (LIBS) is an effective technique for the detection of a wide variety of materials. For example, it can be used to detect potentially hazardous materials, or biological and chemical explosives, at standoff distances. The efficiency of the system determines the requirements on laser size and collection optics. By increasing the efficiency of the LIBS process, the requirements on laser energy, detector efficiency, cost, reliability, and weight can be reduced.

### SUMMARY

In one aspect, in general, a method for analyzing a material using pulses is provided. The method includes applying a first pulse and a second pulse to the material, the second pulse being delayed relative to the first pulse; directing the first and second pulses toward a material along collinear paths; ablating the material using the first pulse to cause particles and a plasma to be emitted from the surface of the material; atomizing or ionizing the emitted particles using the second pulse; and analyzing spectral content of radiation from the atomized or ionized particles. In this manner, the current invention teaches the art of separating the ablation process from the second pulse interaction where the enhanced signal is produced.

Implementations of the method may include one or more of the following features. The method can include focusing the first pulse with a first focal position in a vicinity of the surface of the material, and focusing the second pulse with a second focal position different from the first focal position and at a distance from the surface of the material. The first focal position can be below the surface of the material. The method can include shaping the second pulse to have an annular distribution. The method can include improving the signal-to-noise ratio of a signal having information about the spectral content by adjusting the delay between the first and second pulses. The method can include using a controller to automatically adjust and optimize the delay between the first and second pulses using feedback information from the detected radiation to maximize the signal-to-noise ratio. The time delay between the first and second pulses can correspond to a time period for the emitted particles to travel to the second focal position. The time delay between the first and second pulses can be less than 1 nanosecond, in a range between 10 to 100 picoseconds, or in a range between 30 to 50 picoseconds. The method can include passing a laser pulse through a beam splitter to generate the first and second pulses, and passing the second pulse through an interferometer to introduce the delay in the second pulse. The method can include improving the signal-to-noise ratio of a signal having information about the spectral content by adjusting the location of the second focal position relative to the surface of the material. The method can include using a data processor to automatically determine an optimized location of the second focal position using feedback information from the detected radiation of the atomized or ionized particles to maximize the signal-to-noise ratio. The first pulse can include a laser pulse, and the method can include generating near field laser produced filaments from at least one of the first or second laser pulse. A near field filament is a result of a nonlinear process that occurs when the local intensity of the laser power exceeds P_{cr} (where P_{cr} is the critical power for filament formation). Generally this is a result of non-uniform electric field intensities across the focused laser spot volume. The non-uniform electric fields are a result of the way a lens or set of lenses focuses the light due to spherical and chromatic aberrations in the optical system. In this invention, this can be controlled by the selection of the lens used in the optical path and controlling the chirp of the pulse. The method can include generating an annular particle cloud from the particles emitted from the material. The method can include shaping the second pulse to have an annular distribution at the second focal position, the annular distribution having a dimension that matches the dimension of the annular particle cloud. The dimension can be, e.g., the outer diameter or ring width of the annular distribution. The particles emitted from the material can be, e.g., micro-particles and/or nanoparticles.

In another aspect, in general, an apparatus for performing laser induced breakdown spectroscopy is provided. The apparatus includes a pulse generator configured to generate a first pulse and a second pulse that is delayed relative to the first pulse; an optical module configured to direct the first and second pulses toward a material along collinear paths, in which the first laser pulse is configured to ablate the material to cause particles to be emitted from the surface of the material, and the second pulse is configured to atomize or ionize the particles emitted from the material; and a detector to detect radiation from the atomized or ionized particles.

Implementations of the apparatus may include one or more of the following features. The optical module can include one or more lenses to focus the first pulse at a first focal position in a vicinity of the surface of the material, and to focus the second pulse at a second focal position different from the first focal position and at a distance from the surface of the material. The optical module can be configured to focus the first pulse at a focal position that is below the surface of the material. The optical module can include an axicon lens to cause the second pulse to have an annular distribution. The particles emitted from the surface of material can form an annular particle cloud, and the annular distribution of the second pulse can have a dimension that matches a corresponding dimension of the annular particle cloud. For example, the dimension can be the outer radius or the ring width of the annular distribution. The optical module can include a pair of axicon lenses to cause the second laser pulse to have an annular distribution in which the outer radius of the annular distribution is dependent on a distance between the axicon lenses. The apparatus can include a controller that is configured to automatically adjust and optimize the distance between the axicon lenses to optimize the annular distribution of the second laser pulse to maximize a signal-to-noise ratio of a signal having information about the spectral content. The pulse generator can include a variable delay module to enable adjustment of the delay between the first and second laser pulses. The apparatus can include a controller to automatically adjust and optimize the delay between the first and second pulses using feedback information from the detected radiation to maximize the signal-to-noise ratio. The variable delay module can include an interferometer having a variable delay line. The time delay between the first and second pulses can correspond to a time period for the emitted particles to travel to the second focal position. The time delay between the first and second pulses can be less than 1 nanosecond, in a range between 10 to 100 picoseconds, or in a range between 30 to 50 picoseconds. The pulse generator can include a laser source that generates a laser pulse, and a beam splitter to split the laser pulse to generate the first and second pulses. The pulse generator can include an interferometer having a delay line to introduce the delay in the second pulse. The apparatus can include a controller to automatically adjust and optimize the second focal position relative to the surface of the material using feedback information from the detected radiation of the atomized or ionized particles to maximize a signal-to-noise ratio of a signal having information about the spectral content. The pulse generator can include a laser pulse generator, the first and second pulses can be laser pulses, and the optical module can be configured to cause chirping in at least one of the first or second laser pulse to generate near field laser filaments. The apparatus can control the optical lenses to enhance the formation of near field filaments by a slight misalignment of the lens to enhance the local electric field intensities.

In another aspect, in general, an apparatus includes means for generating a first pulse and a second pulse that is delayed relative to the first pulse; means for directing the first and second pulses toward a material along collinear paths, in which the first laser pulse is configured to ablate the material to cause particles to be emitted from the surface of the material, and the second pulse is configured to atomize or ionize the particles emitted from the material; and means for detecting radiation from the atomized or ionized particles.

### DESCRIPTION OF DRAWINGS

FIG. 1 is a diagram of an example system for performing laser induced breakdown spectroscopy.

FIG. 2A is a diagram showing different focal positions for two laser pulses.

FIG. 2B is a diagram showing a time delay between two laser pulses.

FIG. 3 is a schematic diagram of an experiment setup used to capture particles ejected during femtosecond laser ablation.

FIG. 4 is a diagram of an axicon lens pair generating an annular light distribution.

FIG. 5 is a graph showing inner and outer diameters of an annular ring distribution of emitted particles during femtosecond laser ablation as a function of collection distance.

FIG. 6A is a graph showing spectrometer counts as a function of delay for the zinc 636.234 nm spectral line.

FIG. 6B is a graph showing spectrometer counts as a function of delay for the copper 515.324 nm spectral lines.

FIG. 7 is a graph showing enhancement of the LIBS signal by using a dual-pulse-dual-focus configuration.

FIG. 8 is a graph showing the effect of dual pulse overlap mismatch parallel and perpendicular to the detector plane.

FIG. 9 is a graph showing the spectrum of a laser pulse emitted from the laser source and the pulse spectrum when air breakdown occurs at the focal position.

### DETAILED DESCRIPTION

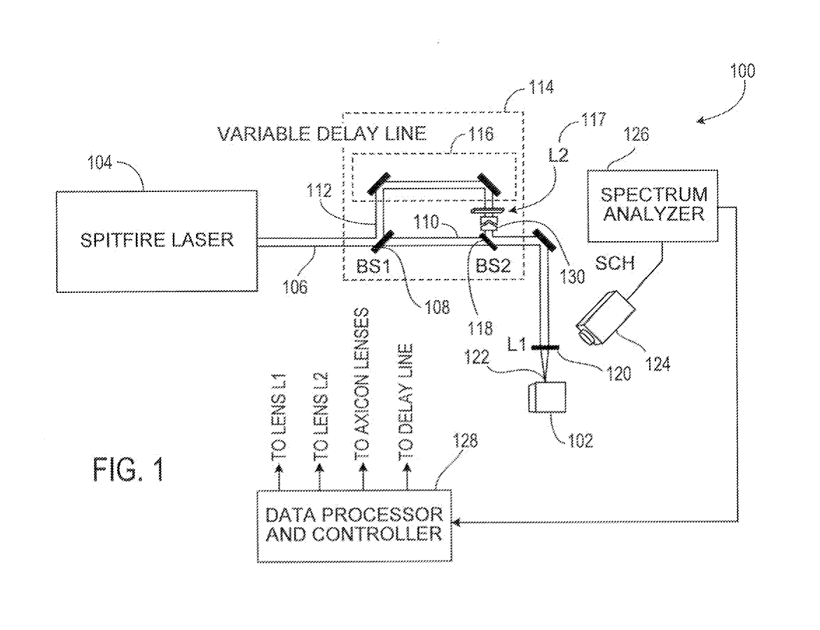

Referring to FIG. 1, a system 100 for performing laser induced breakdown spectroscopy (LIBS) uses a collinear dual-pulse-dual-focus configuration to efficiently generate LIBS signals from a target material 102 and particles ejected from the target material 102 during ablation. The system 100 combines a spot focus ablation pulse and an annular secondary pulse to efficiently atomize ejected particles, enhancing the signal-to-noise ratio of the LIBS signal. The system 100 separates the ablation process from the process of forming the LIBS signal, thereby increasing the signal-to-noise ratio. Two collinear femtosecond laser pulses are incident on the target material 102. The two pulses are separated by a variable time delay (dual-pulse) and their focal positions can be varied relative to each other (dual-focus). The adjustable relative time delay and the adjustable relative focal positions provide a large amount of freedom to optimize the LIBS process. By using a collinear configuration, the system 100 is suitable for field applications and stand-off detection. The dual-pulse and dual-focus configuration allows the laser pulses to interact with the target material surface and the ejected particles separately in both space and time, allowing the separation of the ablation process and the LIBS signal generation process, thereby increasing the signal-to-noise ratio (SNR) of the LIBS signals.

In some implementations, the system 100 includes a laser source 104 that generates a laser beam, which can include a series of laser pulses 106. For example, the laser source 104 can be a Spectra Physics Spitfire system that produces 50 femtosecond (fs) pulses having maximum pulse energy of 1 mJ with a center wavelength of 800 nm. FIG. 1 shows a schematic diagram of example beam paths of the system 100. Other configurations can also be used. In this example, each pulse 106 passes through a beam splitter BS1 108 and is split into a first pulse 110 and a second pulse 112.

The beam splitter BS1 108 is the start of an interferometer 114, which can be, e.g., a Mach-Zehnder interferometer. The beam splitter BS1 108 can be, e.g., a 50:50 beam splitter in which the first pulse 110 and the second pulse have equal energy. In other examples, the amount of energy directed to each of the first and second pulses can be selected to optimize the signal-to-noise ratio of the LIBS signal. For example, a 30:70 beam splitter can be used to allocate 30% of the energy to the first pulse and 70% of the energy to the second pulse.

One branch (referred to as the delay branch) of the interferometer 114 has a variable delay line 116 to control the time delay between the first and second pulses. The delay line 116 may have two mirrors on a translation stage, and the delay introduced in the second pulse can be adjusted by varying the spacing between the mirrors. The delay branch also has a long focal length lens L2 117 that allows the focal position of the delayed second pulse 112 to be different than that of the first pulse 110. The first pulse 110 and the second pulse 112 pass a second beam splitter BS2 118 that causes the first and second pulses to become collinear. The first and second pulses then pass a common focusing lens L1 120 and travel toward the target material 102. Because laser pulses (instead of a continuous beam) are sent through the interferometer 114, the first and second pulses do not interfere with each other if the time delay is greater than the pulse duration.

The focusing lens 120 is configured such that the first pulse 110 is focused at or near the surface 122 of the material 102. In some examples, the focal position of the first pulse 110 is slightly below the surface 122 of the material 102. Due to the high intensity of the short laser pulse, breakdown of air may occur at the focal point of the first pulse, producing a continuum of emitted spectrum, raising the noise floor of the LIBS signal. By placing the surface 122 of the target material 102 closer to the lens 120 than the focal position, the first pulse 110 reaches the target material surface 122 before air breakdown occurs. Placing the surface 122 of the target material 102 closer to the lens 120 than the focal position enhances the formation of particles due to the concentric ring melting that produces the nanoparticles.

In some implementations, the delay branch includes a matched axicon lens pair 130 that causes the second pulse 112 to have an annular light distribution. When laser ablation is carried out with a beam having a Gaussian cross-sectional profile and focused by a spherical lens, the intensity distribution at the focal position is not uniform. At intensities high enough to be useful for LIBS, the center of the focus has a very high intensity capable of atomizing and ionizing the target material 102. Areas farther from the center of ablation are irradiated with enough intensity to ablate the target material 102, but the ablated material is not fully atomized, producing fragments and nanoparticles as the result of the less intense ablation. The particles ejected from the material 102 due to ablation may not be uniform across the beam diameter. For example, the emitted particles may initially form a doughnut-shaped cloud. The axicon lens pair produces an annular intensity distribution in the second pulse 112 that matches the spatial distribution of the emitted particles. This allows the second pulse to atomize and ionize a large portion of the emitted particles.

In a LIBS process, the useful information comes from atomic emission lines that are primarily emitted by the atomized and ionized particles. Nanoparticles (that are emitted from the surface 122 but have not been atomized and ionized) emit broadband radiation that raises the noise floor in a LIBS spectrum and do not significantly contribute to the quality or quantity of useful LIBS signals. The emitted nanoparticles may still be at an elevated temperature and thus require less energy to atomize and ionize. By applying the first pulse to ablate the target material 102, and then applying the second pulse with an annular intensity distribution after a short time delay, the second pulse can atomize and ionize a large portion of the emitted nanoparticles, such that a higher percentage of the target material 102 is turned to plasma. By atomizing the nanoparticles from the first ablation, the signal strength of atomic emissions produced from the second pulse can be increased and the noise floor can be reduced (due to a reduction in the broadband noise and separating the energy needed for ablation from that which produces the LIBS signal), thereby increasing the signal-to-noise ratio of the LIBS signal. A greater percentage of energy from the laser pulses is used to produce useful LIBS signals.

The delay between the first and second pulses is selected such that the delay is long enough for the nanoparticles to emit from the sample surface, but not too long such that the nanoparticles drift away. For example, the time delay between the first and second pulses can correspond to a time period for the emitted particles to travel to the second focal position. Different time delays may be used for different materials.

The laser 104 generates a series of pulses, and each pulse is split by the beam splitter BS1 108 into two pulses, one delayed relative to the other. The pairs of pulses are directed toward the material 102, resulting in ablation of the material and generation of atomic emissions. The atomic emissions are detected by a detector 124 (spectrometer collection head). The detected signals are sent to a spectrum analyzer 126 that analyzes the signals and determines the spectral content of the atomic emissions from the ablated material.

In some implementations, the position of the lens L2 117 is fixed, and the position of the lens L1 120 and the time delay are adjusted to optimize the LIBS signal. For example, initially the light passing lens L2 117 is blocked, and the position of the lens L1 120 is adjusted so that the focal position is slightly beneath the surface of the material 102. Ablation of the material 102 is performed to confirm that air breakdown has not occurred. Next, the delay between the first and second pulses is adjusted to maximize the LIBS signal.

In some implementations, the detected spectrum signal is sent to a data processor and controller 128 as feedback signal for adjusting one or more of the variable delay line 116, the focusing lens L1 120, the focusing lens L2 127, and the axicon lens pair 130 to maximize the signal-to-noise ratio of the LIBS signal. For example, the position of the focusing lens L1 120 can be adjusted to adjust the focal position of the first pulse 110 to increase the intensity the pulse at the surface 122 of the material without inducing air breakdown. The position of the focusing lens L2 117 may be adjusted to adjust the focal position of the second pulse 112 to match the location of the emitted particle plume to increase the amount emitted particles that are atomized and ionized by the second pulse 112. The distance between the pair of axicon lenses 130 may be adjusted to adjust the annular light distribution of the second pulse to increase the amount of emitted particles that are atomized and ionized by the second pulse. The variable delay line 114 may be adjusted to optimize the delay between the first and second pulses so that the arrival of the second pulse 112 at the focal position coincides with the arrival of the emitted particles.

The adjustments performed by the data processor and controller 128 can be automatic without intervention from a human operator. For example, the operator may point the system 100 toward a target material, turn on the system 100, and initiate a process for analyzing the material. The process may involve executing a computer program for controlling various components, such as the delay line 116, actuators for positioning and aligning the lenses L1 120 and L2 117, and the axicon lens pair 130. For example, the process may include controlling the interferometer 114 to block the path of the second pulse 112, then move the lens L1 120 to various positions while at the same time measure the LIBS signals. The position of the lens L1 120 resulting in the highest amplitude for the LIBS signals is determined. The process may include allowing the second pulse to pass, then adjust the time delay between the first and second pulses while at the same time measure the LIBS signals. The delay resulting in the highest signal-to-noise ratio for the LIBS signals is determined.

An advantage of the system 100 is that the second pulse can efficiently couple energy into particles emitted from the material 102, so the LIBS signal is much more uniform from pulse to pulse. Therefore, it may be possible to obtain quantitative information, such as determining the percentage of certain component within the material 102.

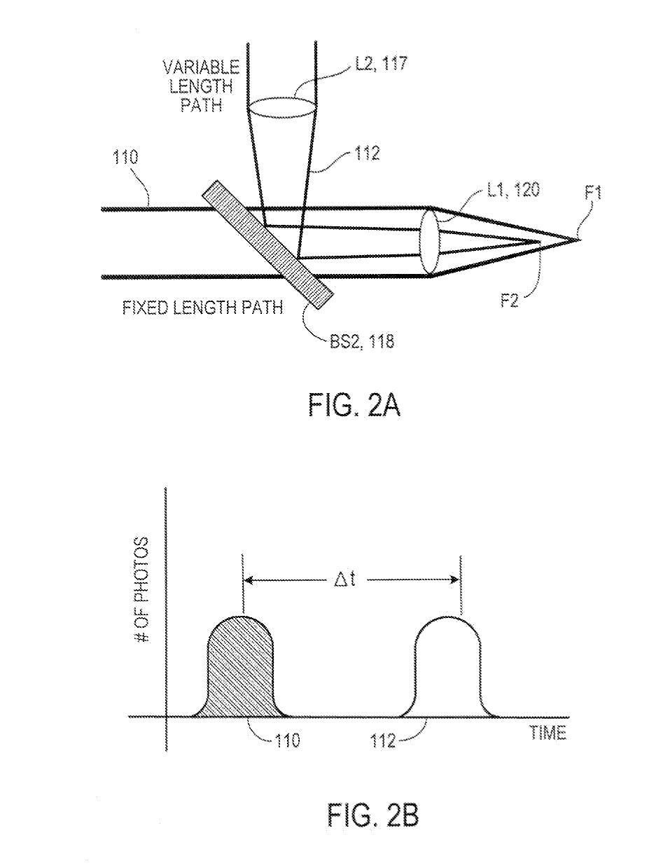

Referring to FIG. 2A, the first pulse 110 passes the beam splitter BS2 118, while the second pulse 112 is reflected by the beam splitter BS2, so that the first and second pulses become collinear as the pulses approach the material 102. The focal position F1 of the first pulse 110 is determined by the focusing liens L1 120. By using the long focal lens L2 117 in the path of the second pulse 112, the focal position F2 of the second pulse 112 can be different from the focal position F1.

Referring to FIG. 2B, by passing the second pulse 112 through the delay line 116, the second pulse 112 is delayed by Δt relative to the first pulse 110.

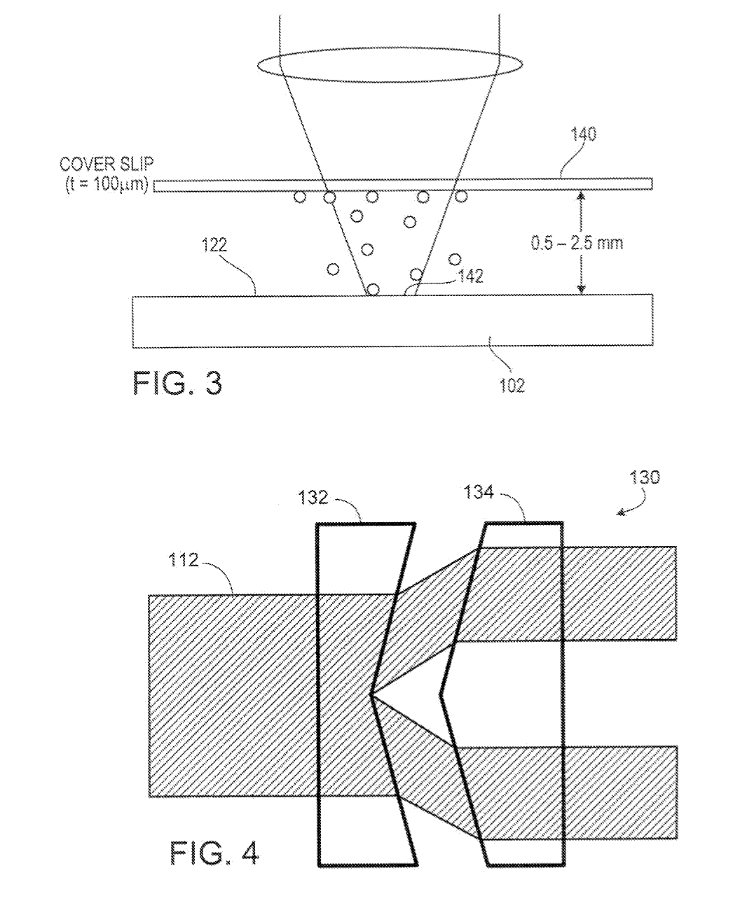

Referring to FIG. 3, the spatial distribution of particles ejected during femtosecond laser ablation has been analyzed by placing a transparent collection plate 140 near the ablation site 142 and observing the distribution of the collected particles. The collection plate 140 was a 100 μm thick microscope cover slip and was placed parallel to the surface 122 of the sample material 102 with a separation distance ranging from 1.5 mm to 2.5 mm. The use of a thin collection plate minimized aberrations of the focused beam.

A film of Rhodamine 6G dye was ablated, and images of the distribution of particles from the ablation were collected. A bright-field optical microscope image was compared with an image taken with crossed polarizers. The dye sample was prepared by drying liquid dye on a microscope slide. The fluence of the laser was set to 530 mJ/cm², which was lower than the ablation threshold of the substrate, in order to ensure that only the dye was ablated. The separation between the sample and the collection plate was 2 mm. The number of pulses incident on the sample was 2500.

The bright-field image showed a distribution of particles over several hundred microns with a large concentration of particles in an annular distribution with an average diameter of approximately 160 μm. Viewing the particles through crossed polarizers allows the red dye particles to be clearly observed and the annular distribution of concentrated particles was well visualized. The annular distribution is likely due to a combination of gradient of the laser irradiance across the Gaussian beam and the expansion of a shock wave from the ablation site. The Gaussian distribution of the laser beam results in a relatively high irradiance in the center of the beam compared to the outer edges. This results in a gradient of the temperature of the material after the absorption of the laser energy, which in turn results in varying material response across the beam. The reduced material temperature on the outer edges of the irradiated region results in less efficient atomization than the center of the beam and increased generation of larger particles that are ejected during ablation. Additionally, the shock wave generated during ablation provides an outward force that expels particles away from the center of the plasma.

In order to observe the variation of the ejected particle distribution as a function of laser fluence, the above experiment was repeated for fluences ranging from 530 mJ/cm² to 3 J/cm². The ejected particle distributions viewed through crossed polarizers were also obtained.

As the laser power is increased, the distribution of the ejected dye particles spreads. The increased fluence across the entire beam profile results in an increase in the temperature of the material in the focal volume during ablation and thus simultaneously increases the efficiency of atomization and decreases the generation of large particles. The annular distribution of ejected particles is not unique to Rhodamine 6G dye. Once the ablation threshold of the substrate material is reached, the outer diameter of the distribution of the dye particles increases beyond 400 μm and becomes less defined. However, the ablated glass substrate particles do show a well-defined annular distribution of a relatively larger concentration of particles.

The ejection angle of ablated particles was determined by capturing ablated particles at varying distances from the sample surface. The laser fluence was set to 530 mJ/cm² such that only the Rhodamine 6G dye was ablated with the substrate left undamaged. The collection distance was varied from 0.5 to 2.5 mm. Each image collected represents an accumulation of 2500 laser shots on the sample. Particles ejected during femtosecond laser ablation fall into two classes: (i) a first group of particles that forms a plume, has a wide ejection angle, disperses rapidly, and is observable for small collection distances, and (ii) a second group of particles that has an annular distribution and a narrower ejection angle.

Images of collected particles at 0.5 and 1 mm collection distances demonstrate the large angle ejection with captured particles having ejection angles of up to 35°. The concentration of these particles is highest for smaller angles and decreases with increasing angle. A significant amount of particles are captured by the collection plate 140 and can be easily observed by bright-field microscopy.

For collection distances greater than 1 mm, the wide ejection angle particles are sparser and the annular distribution can be clearly seen. Optical microscope images for collection distances between 1.5 mm and 2.5 mm were obtained. The images were taken with crossed polarizers for better visibility.

In order to efficiently couple the second laser pulse 112 to the ejected nanoparticles, the second laser pulse 112 should also have an annular distribution. This can be accomplished through the axicon lens pair 130.

Referring to FIG. 4, the axicon lens pair 130 includes a first axicon lens 132 having an inward facing cone and a second axicon lens 134 having an outward facing cone with matching cone angles. The axicon lens pair 130 converts a beam having a Gaussian distribution into a beam having an annular distribution with a dark center. The diameter of the ring can be controlled by adjusting the distance between the pair of axicon lenses 132, 134. FIG. 4 shows the axicon pair 130 forming a hollow cylinder of light. By focusing the output of the axicon pair 130, it is possible to obtain an annular beam profile.

The alignment of the axicon lenses 132, 134 with respect to the center of the beam, and the alignment of the cone apexes relative to each other to ensure that the cone apexes are collinear, require a high degree of accuracy. Misalignments of the axicon pair as small as, e.g., 200 μm can significantly affect the intensity distribution causing hotspots and non-circular ablation. Scanning electron microscope (SEM) images show a near-circular and misaligned ablation pattern on an aluminum target. When the pair of axicon lenses is aligned, a circular pattern is generated.

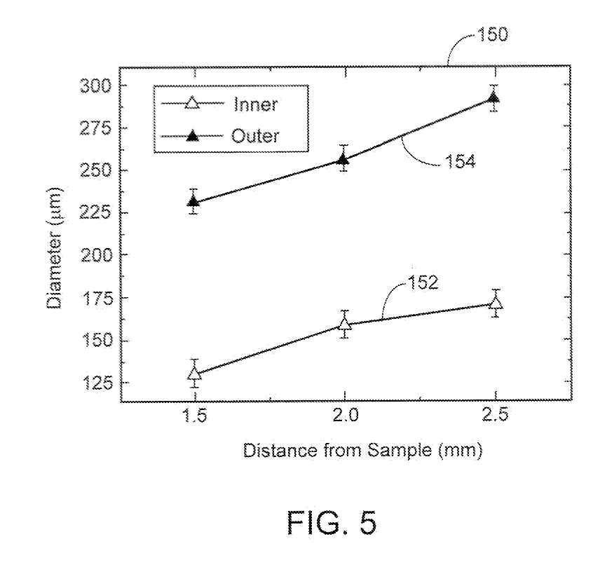

Referring to FIG. 5, a graph 150 shows a line 152 representing the inner diameter of the annular distribution of the ejected particles as a function of the collection distance. A line 154 represents the outer diameter of the annular distribution of the ejected particles as a function of the collection distance.

As the ejected particles expand from the surface of the material 102, both the inner and outer diameters of the annular distribution increase almost linearly. In this example, the rate of expansion is about 41 and 61 microns per millimeter of separation from the material surface for the inner and outer diameters, respectively. This equates to about 1.17° and 1.75° expansion angles for the inner and outer regions of the annular distribution. These particles propagate beyond the plasma and can be ablated by a second femtosecond laser pulse with an appropriately sized annular distribution, such as the annular distribution generated by the axicon lens pair 130 shown in FIG. 4.

Without being bound by the theory presented here, the following is a description of near field filaments that can be used to enhance the LIBS signals. Either by misalignment of the optics or by adjustment of the chirp of the pulse, localized hot spots of electric fields with very high intensities can be generated. The high intensity electric fields cause Kerr-induced self-focusing. Due to non-linear optical effects, the refractive index of air becomes larger in the areas where the beam intensity is higher, usually at the center of a beam, creating a focusing density profile. When the power of the beam exceeds a critical threshold, air molecules start to ionize to form a plasma that may have a defocusing effect. The filaments are the result of a balancing between the Kerr focusing effect and the plasma defocusing effect. The filaments result in shortening of the pulse and broadening of the pulse spectrum. For example, the original laser pulse may have a duration of about 30 to 50 femtoseconds, whereas the filament may have a duration of about 4 to 7 femtoseconds.

The near field laser filaments are generated near the focus and may not support propagation into the far field. In some examples, the near field laser filaments are formed within a short distance (e.g., about 7 mm) on either side of focus. The near field laser filaments are formed due to nonlinear processes occurring in a mixture of vaporized material, air molecules, and plasma. By comparison, the formation of far field laser filaments is associated with the nonlinear properties of air. One or more near field laser filaments can be derived from a short laser pulse depending on how many localized hot spots occur.

Filaments can be generated from the first pulse 110, the second pulse 112, or both. Filaments can be generated from the first pulse 110 due to misalignment of the optics or by spherical aberration in the lens itself, or by adjustment of the chirp of the first pulse 110. This generates localized hot spots of electric fields near the surface 122 of the target material 102. The peak power of the filaments are higher than the original pulse, so a higher percentage of material 102 can be atomized and ionized to form a plasma and produce useful LIBS signals.

Similarly, filaments can be generated from the second pulse 112 due to misalignment of the optics or by adjustment of the chirp of the second pulse 112. This generates localized hot spots of electric fields near the focal position of the second pulse 112. The filaments result in shortening of the second pulse 112, e.g., 4 to 7 femtoseconds as compared to 30 to 50 femtoseconds for the original pulse, and broadening of the spectrum of the second pulse 112.

By broadening of the spectrum of the second pulse 112, the amount of emitted particles that are ionized can be increased. This is because the particles emitted from the material 102 has many sizes, having dimensions ranging from, e.g., a few nanometers to several microns. For a given material, the energy band gap of a particle may vary depending on the particle size. This effect is more significant as the size of the particle decreases. Particles of a particular size may more easily absorb radiation having a particular energy or wavelength. Thus, when the particles emitted from the material 102 has varying sizes, using a second pulse 112 with a broader spectrum can ionize a greater portion of the particles and produce more useful LIBS signals.

Advantages of the system 100 may include the following. The combination of a spot focus ablation pulse and a delayed annular secondary pulse can efficiently atomize ejected material. Near focus filaments can enhance the ablation process from the first laser pulse. This method of increasing the signal-to-noise ratio of the LIBS signal can be applied to millisecond, microsecond, picosecond, femtosecond, and atto-second LIBS processes.

An experiment was conducted in which a dual-pulse-dual-focus (DPDF) system was used to apply a first pulse having a Gaussian profile and a second pulse having an annular profile to target materials, including brass 220 and brass 260. Brass 220 includes 10% zinc while brass 260 includes 29% zinc. A series of pulses were applied to each sample, and the LIBS signals were measured and analyzed to determine the percentage of zinc signal relative to the copper signal.

As shown in Table 1 below, the percentage of the zinc signal relative to the copper signal is directly correlated (by a factor of 2) to the percentage of zinc in the sample. This shows that the use of the annular DPDF geometry can provide accurate quantitative data about the relative ratios of constituent species in a sample.

TABLE 1

| | Percentage of zinc | Percentage of zinc |
|---|---|---|
| Sample | in the sample | signal |
| Brass 220 | 10% | 5.76% |
| Brass 260 | 29% | 14.5% |

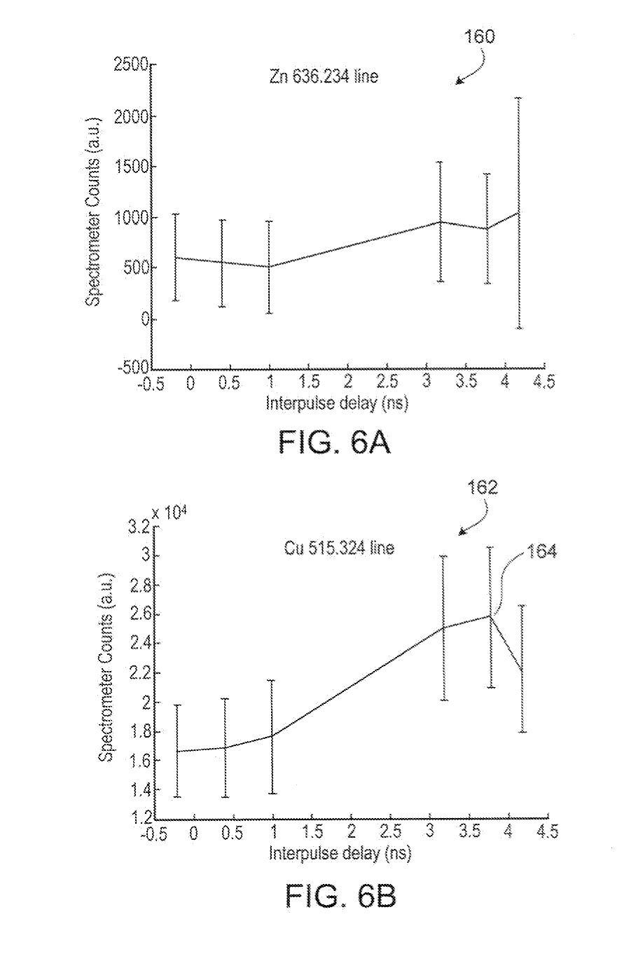

Referring to FIGS. 6A and 6B, a dual-pulse-dual-focus (DPDF) system was used to apply a first pulse having Gaussian profile and a second pulse having an annular profile to a brass 220 target. The inter-pulse delay between the first and second pulses was varied from about 0 to 4.5 ns. FIG. 6A is a graph 160 showing the spectrometer counts as a function of delay for the zinc 636.234 nm spectral line. FIG. 6B is a graph 162 showing the spectrometer counts as a function of delay for the copper 515.324 nm spectral line. In FIG. 6B, a peak 164 appears when the inter-pulse delay is about 3.8 ns. For this example, when the second pulse 112 is delayed about 3.8 ns relative to the first pulse 110, the maximum SNR for the copper 515.324 nm spectral line can be achieved.

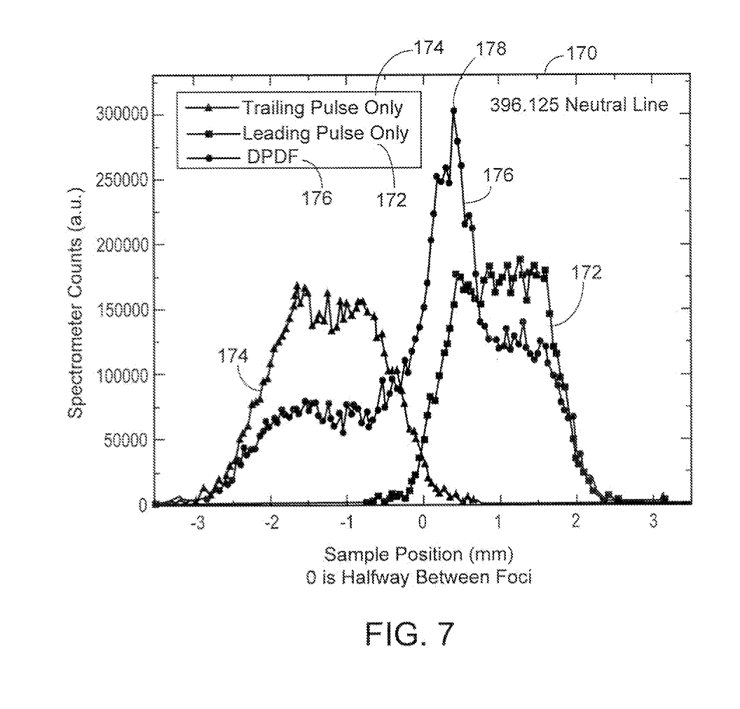

Referring to FIG. 7, a graph 170 shows a comparison of the LIBS signal strengths obtained under three situations: (1) when only the first pulse is used, (ii) when only the second pulse is used, and (iii) when both pulses are used. The horizontal axis represents the position of the sample material, in which the zero value represents a location halfway between the two focal positions. The vertical axis represents the spectrometer counts. When only the first pulse is used, the beam path for the second pulse 112 is blocked, and a series of first pulses are directed toward the sample. When only the second pulse is used, the beam path for the first pulse 110 is blocked, and a series of second pulses are directed toward the sample.

In this example, the pulses are directed to a target sample made of aluminum. The LIBS signal represents the 396.125 nm spectral line. A line 172 represents the LIBS signal when only the first pulse 110 is used. A line 174 represents the LIBS signal when only the second pulse 112 is used. A line 176 represents the LIBS signal when both the first and second pulses are used. The first and second pulses have different focal positions.

When both the first and second pulses are used, there is a sweet spot between the two focal positions that provides an enhancement of the LIBS signal, as indicated by the peak 178 of the line 176. The peak 178 is located more towards the leading pulse. In this example, when both the first and second pulses are used, the LIBS signal has an amplitude about twice as much as that of the LIBS signal generated when only either the first or second pulse is used. Such an increase in amplitude is important when performing standoff detection using laser induced breakdown spectroscopy. By further optimizing the system, the amplitude of the LIBS signal can be further increased.

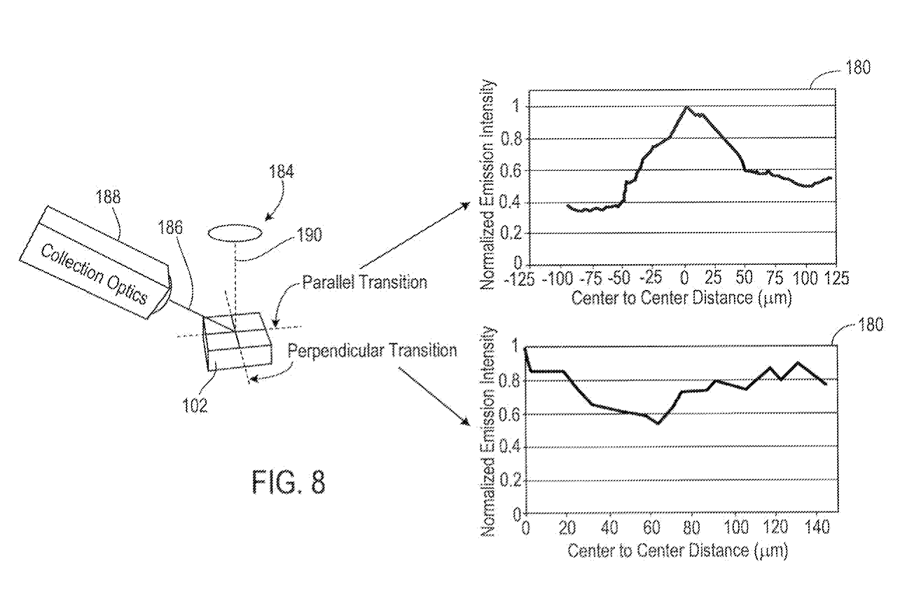

Referring to FIG. 8, a graph 180 shows the effect of dual pulse overlap mismatch parallel to the detector plane when the measurement set up 184 is used. A graph 182 shows the effect of dual pulse overlap mismatch perpendicular to the detector plane. The detector plane refers to the plane formed by the axis 186 of the collection optics 188 and the normal 190 to the surface of the sample material 102.

For the graph 180, the sample material was moved parallel to the detector plane. For the graph 182, the sample material was moved perpendicular to the detector plane. Comparing the graphs 180 and 182 indicates that the measurements are more sensitive to parallel movement as compared to perpendicular movement of the sample.

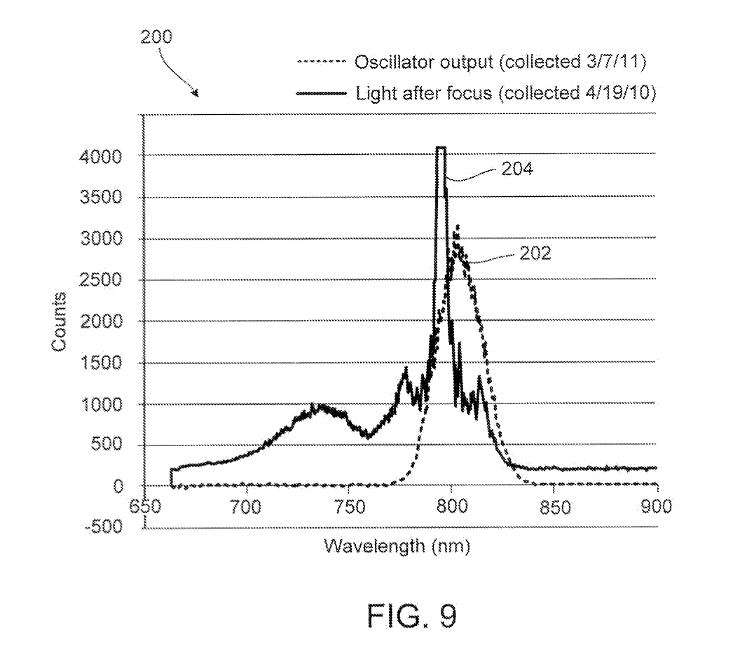

Referring to FIG. 9, a graph 200 shows a spectrum 202 of a laser pulse that was emitted from the laser source 104, and a spectrum 202 of the laser pulse after being focused at the focal position. The measurements for the graph 200 were obtained without placing the sample material 102 in the beam path. The spectrum 202 shows that the laser pulse generated by the laser has a narrow spectrum in a range between about 770 nm to 840 nm. By contrast, the spectrum 204 shows that the laser pulse after being focused has a wide spectrum. This is because the short laser pulse has a high intensity at the focal position, causing air breakdown that generates a broad spectrum of radiation. Thus, if the focal position of the lens L1 120 is located before the surface 122 of the sample material 102, air breakdown may occur, causing the spectrum of the pulse to broaden and the LIBS signal to be weakened. The air breakdown also causes the ablation spot to increase, resulting in lower efficiency in material ablation because the light intensity is reduced.

In some implementations, the data processor and controller 128 can be part of a computer that includes a memory device, a storage device, and an input/output device. The data processor is capable of processing instructions for execution to achieve adjustment of the delay line 116 and various lenses 117, 120, and 130. The instructions can be part of a computer program stored in the memory or the storage device. The input/output device may display graphical information for a user interface and allow a human operator to adjust parameters to further optimize the system 100. The memory can include volatile memory and/or non-volatile memory. The storage device is capable of providing mass storage for the system 100, such as storing data representing the LIBS signals gathered by the spectrum analyzer 126. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. For example, the axicon lens pair 130 is optional and can be omitted. The laser source 104, the interferometer 114, the detector 124, the spectrum analyzer 126, the lens L1, and the data processor and controller 128 can all be placed in a portable package that can be carried in the field for performing standoff detection operations. Different types of interferometers can be used. The delay between the first and second pulses can be generated using other methods. The amount of delay between the first and second pulses can be different from the values described above. Additional optical elements, such as reflectors or lenses, can be used to change the beam path or pulse shape to further optimize the LIBS signals. The ratio of energy provided to the first and second pulses can be different from those described above. For example, more energy can be allocated to the second pulse because it has an annular distribution with a greater cross sectional area than the first pulse. The data processor and controller 128 is optional. The adjustment of the position of the delay line and the lenses can be performed manually.

Accordingly, other implementations are within the scope of the following claims.

What is claimed is:

1. A method for analyzing a material using pulses, the method comprising:
applying a first pulse and a second pulse to the material, the second pulse being delayed relative to the first pulse;
directing the first and second pulses toward a material along collinear paths;
ablating the material using the first pulse to cause particles to be emitted from the surface of the material;
atomizing or ionizing the emitted particles using the second pulse; and
analyzing spectral content of radiation from the atomized or ionized particles.

2. The method of claim 1, comprising focusing the first pulse with a first focal position in a vicinity of the surface of the material, and focusing the second pulse with a second focal position different from the first focal position and at a distance from the surface of the material.

3. The method of claim 1 in which the first focal position is below the surface of the material.

4. The method of claim 1, comprising shaping the second pulse to have an annular distribution.

5. The method of claim 1, comprising improving the signal-to-noise ratio of a signal having information about the spectral content by adjusting the delay between the first and second pulses.

6. The method of claim 5, comprising using a controller to automatically adjust and optimize the delay between the first and second pulses using feedback information from the detected radiation to maximize the signal-to-noise ratio.

7. The method of claim 1 in which the time delay between the first and second pulses correspond to a time period for the emitted particles to travel to the second focal position.

8. The method of claim 1 in which the time delay between the first and second pulses is less than 1 nanosecond.

9. The method of claim 1 in which the time delay between the first and second pulses is in a range between 10 to 100 picoseconds.

10. The method of claim 1 in which the time delay between the first and second pulses is in a range between 30 to 50 picoseconds.

11. The method of claim 1, comprising passing a laser pulse through a beam splitter to generate the first and second pulses, and passing the second pulse through an interferometer to introduce the delay in the second pulse.

12. The method of claim 1, comprising improving the signal-to-noise ratio of a signal having information about the spectral content by adjusting the location of the second focal position relative to the surface of the material.

13. The method of claim 12, comprising using a data processor to automatically determine an optimized location of the second focal position using feedback information from the detected radiation of the atomized or ionized particles to maximize the signal-to-noise ratio.

14. The method of claim 1 in which the first pulse comprises a laser pulse, and the method comprises generating near field laser filaments from at least one of the first or second laser pulse.

15. The method of claim 14, comprising controlling misalignment of optical lenses to enhance local electric field intensities and enhance the generation of near field filaments.

16. The method of claim 1, comprising generating an annular particle cloud from the particles emitted from the material.

17. The method of claim 16, comprising shaping the second pulse to have an annular distribution at the second focal position, the annular distribution having a dimension that matches the dimension of the annular particle cloud.

18. The method of claim 17 in which the dimension comprises an outer diameter or a ring width of the annular distribution.

19. The method of claim 1 in which ablating the material comprises ablating the material to cause at least one of micro-particles or nanoparticles to be emitted from the material.

20. A apparatus for performing laser induced breakdown spectroscopy, the apparatus comprising:
a pulse generator configured to generate a first pulse and a second pulse that is delayed relative to the first pulse;
an optical module configured to direct the first and second pulses toward a material along collinear paths, in which the first laser pulse is configured to ablate the material to cause particles to be emitted from the surface of the material, and the second pulse is configured to atomize or ionize the particles emitted from the material; and
a detector to detect radiation from the atomized or ionized particles.

21. The apparatus of claim 20 in which the optical module comprises one or more lenses to focus the first pulse at a first focal position in a vicinity of the surface of the material, and to focus the second pulse at a second focal position different from the first focal position and at a distance from the surface of the material.

22. The apparatus of claim 20 in which the optical module is configured to focus the first pulse at a focal position that is below the surface of the material.

23. The apparatus of claim 20 in which the optical module comprises an axicon lens to cause the second pulse to have an annular distribution.

24. The apparatus of claim 20 in which the particles emitted from the surface of material form an annular particle cloud, and the annular distribution of the second pulse has a dimension that matches a corresponding dimension of the annular particle cloud.

25. The apparatus of claim 24 in which the dimension comprises an outer diameter or a ring width of the annular distribution.

26. The apparatus of claim 20 in which the optical module comprises a pair of axicon lenses to cause the second laser pulse to have an annular distribution in which the outer diameter of the annular distribution is dependent on a distance between the axicon lenses.

27. The apparatus of claim 20, comprising a controller that is configured to automatically adjust and optimize the distance between the axicon lenses to optimize the annular distribution of the second laser pulse to maximize a signal-to-noise ratio of a signal having information about the spectral content.

28. The apparatus of claim 20 in which the pulse generator comprises a variable delay module to enable adjustment of the delay between the first and second laser pulses.

29. The apparatus of claim 28, comprising a controller to automatically adjust and optimize the delay between the first and second pulses using feedback information from the detected radiation to maximize the signal-to-noise ratio.

30. The apparatus of claim 28 in which the variable delay module comprises an interferometer having a variable delay line.

31. The apparatus of claim 20 in which the time delay between the first and second pulses correspond to a time period for the emitted particles to travel to the second focal position.

32. The apparatus of claim 20 in which the time delay between the first and second pulses is less than 1 nanosecond.

33. The apparatus of claim 20 in which the time delay between the first and second pulses is in a range between 10 to 100 picoseconds.

34. The apparatus of claim 20 in which the time delay between the first and second pulses is in a range between 30 to 50 picoseconds.

35. The apparatus of claim 20 in which the pulse generator comprises:
a laser source that generates a laser pulse, and
a beam splitter to split the laser pulse to generate the first and second pulses.

36. The apparatus of claim 20 in which the pulse generator comprises an interferometer having a delay line to introduce the delay in the second pulse.

37. The apparatus of claim 20, comprising a controller to automatically adjust and optimize the second focal position relative to the surface of the material using feedback information from the detected radiation of the atomized or ionized particles to maximize a signal-to-noise ratio of a signal having information about the spectral content.

38. The apparatus of claim 20 in which the pulse generator comprises a laser pulse generator, the first and second pulses being laser pulses, and the optical module is configured to cause chirping in at least one of the first or second laser pulse to generate near field laser filaments.

39. An apparatus comprising:
means for generating a first pulse and a second pulse that is delayed relative to the first pulse;
means for directing the first and second pulses toward a material along collinear paths, in which the first laser pulse is configured to ablate the material to cause particles to be emitted from the surface of the material, and the second pulse is configured to atomize or ionize the particles emitted from the material; and
means for detecting radiation from the atomized or ionized particles.
